(19) United States
(12) Patent Application Publication
(10) Pub. No.: US 2015/0046231 A1
(43) Pub. Date: Feb. 12, 2015

(54) SYSTEMS AND METHODS FOR QUALITY ORDER TRACKING

(71) Applicant: Level 3 Communications, LLC, Broomfield, CO (US)

(72) Inventors: Cecil Sunder, Broomfield, CO (US); Ophir Rahmani, Arvada, CO (US); Tara Risser, Golden, CO (US); Derick K. Zines, Denver, CO (US)

(73) Assignee: Level 3 Communications, LLC, Broomfield, CO (US)

(21) Appl. No.: 14/456,823

(22) Filed: Aug. 11, 2014

Related U.S. Application Data
(60) Provisional application No. 61/864,402, filed on Aug. 9, 2013.
(60) Provisional application No. 61/864,411, filed on Aug. 9, 2013.

(51) Int. Cl. G06Q 10/06

(52) U.S. Cl. CPC G06Q 10/06395
USPC 705/7.41

(57) ABSTRACT

Implementations described and claimed herein provide systems and methods for increasing order quality. In one implementation, an order for a product, such as a telecommunication product or service, is received. Information corresponding to critical order attributes is extracted from the order. The critical order attributes include technical data for provisioning the product. The information is automatically validated according to a set of critical-to-quality rules defined based on the product. An auditor review of the information is received. The auditor review assigns a pass/fail status to the order. The validated information is collated with the auditor review to obtain an order status. A determination of whether the order is complete for release to provision the product is based on the order status.

### CROSS-REFERENCE TO RELATED APPLICATIONS

The present application claims benefit under 35 U.S.C. §119(e) to U.S. Provisional Patent Application No. 61/864,402, entitled “Systems and Methods for Quality Order Tracking” and filed on Aug. 9, 2013, and to U.S. Provisional Patent Application No. 61/864,411, entitled “Systems and Methods for Order Attribute Tracking” and filed on Aug. 9, 2013, both of which are specifically incorporated by reference in their entirety herein.

### TECHNICAL FIELD

Aspects of the present disclosure relate to order tracking, collaboration, and management, among other functions, and more particularly to tracking order quality to prevent order defects and eliminate rework.

### BACKGROUND

Industries delivering complex services, such as the telecommunications industry, generally require variability and flexibility in receiving, processing, and delivering an order. For example, a customer may provide needed information pertaining to the order at various times during order processing and/or aspects of the order many change prior to delivery. This often results in the introduction of defects in the order that are carried into the factory, which provisions the order for delivery. Generally, conventional methods fail to identify such defects until the order is submitted to the factory, necessitating a rework of the order. Reworking an order after it has been submitted to the factory often reduces revenue, customer satisfaction, efficiency, productivity, and quality.

It is with these observations in mind, among others, that various aspects of the present disclosure were conceived and developed.

### SUMMARY

Implementations described and claimed herein address the foregoing problems, among others, by providing systems and methods for increasing order quality. In one implementation, an order for a product, such as a telecommunication product or service, is received. Information corresponding to critical order attributes is extracted from the order. The critical order attributes include technical data for provisioning the product. The information is automatically validated according to a set of critical-to-quality rules defined based on the product. An auditor review of the information is received. The auditor review assigns a pass/fail status to the order. The validated information is collated with the auditor review to obtain an order status. A determination of whether the order is complete for release to provision the product is based on the order status.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example order management system, including a tracking system running on a computer server or other similar device coupled with a network, for quality order tracking.

FIG. 2 illustrates example operations for quality order tracking.

FIG. 3 shows an example user interface generated by the tracking system, the user interface being displayed in a browser window of a computing device and displaying an audit tracker.

FIG. 4 displays an example tracking user interface showing a grid list for tracking order quality.

FIG. 5 shows an audit user interface.

FIG. 6 is an example of a computing system that may implement various systems and methods discussed herein.

### DETAILED DESCRIPTION

Aspects of the present disclosure involve systems and methods for tracking order quality to prevent defects and eliminate rework, thereby increasing order quality. In one particular aspect, an order for a telecommunications product is received and information relating to critical attributes that are necessary to complete the order are extracted and collated from the order. The order is assigned to an auditor for review. Critical-to-quality rules are received for the product ordered, and a script is run to validate the information in the order relating to the critical attributes using the critical-to-quality rules. Generally concurrently, the auditor is reviewing the order. Stated differently, the order is processed using an automated and a manual review. The results of the automatic validation and the auditor review are received.

If the order failed one or more of the critical-to-quality rules and/or the auditor review, the order fails and is submitted into a feedback loop that forces the defects to be addressed prior to the order being released to the factory for provisioning the product for the customer. A notification is provided with instructions for correcting defects in the order, such as missing or inadequate critical attributes. The defects are generally changed on the fly, rather than sending the order back to the beginning of the process, which may result in the sales team and/or the customer having to be involved. By not involving the sales team in the correction process, the sales team can focus on productivity and customer relations. Once the order is corrected and passes the automatic and manual review, the corrected order is released to the factory for configuring and delivering the product.

In another aspect, the quality order tracking process involves one or more tiers of critical attribute analysis. Stated differently, the order is processed through one or more stages, where the information in the order is compared to critical attributes at each stage and must pass the stage before continuing in the order process.

In another aspect, analytics and business intelligence are generated based on information from each order. The analytics may include trends, for example, over intervals in a time period or according to product type. The analytics may be used, for example, to identify an accountable party or issue, to prevent recurring defects, and/or to provide a snapshot of order quality.

As such, the systems and methods described herein increase collaboration for identifying, tracking, and remedying defects in an order prior to the order being submitted to the factory for provisioning the product. In some aspects, the quality order tracking process involves automated attribute verification, assignment of orders to auditors, pass/fail of an order based on automatic rules and manual audit rules, and notifications to responsible parties for failed orders. If an order fails, the order is processed using a feedback loop that forces defects to be addressed on the fly prior to the order being sent to the factory. The systems and methods described herein deliver a product (e.g., one or more telecommunication products or services) correct the first time by improving order quality early in the process and reducing rework late in the process. Thus, the systems and methods described herein, eliminate rework, improve productivity and process efficiency, accelerate revenue, increase order quality and customer satisfaction, and provide standardization in tracking and managing orders. Additionally, the systems and methods generate analysis and business intelligence, including trends and defect high bars, to further optimize the order process.

The various systems and methods disclosed herein provide for quality order tracking to prevent defects in orders and eliminate rework, as well as generating analytics and business intelligence. The example implementations discussed herein reference the telecommunications industry. However, it will be appreciated by those skilled in the art that the presently disclosed technology is applicable to other industries and data involving the sale and delivery of complex services, such as the shipping industry, financial industry, and the like.

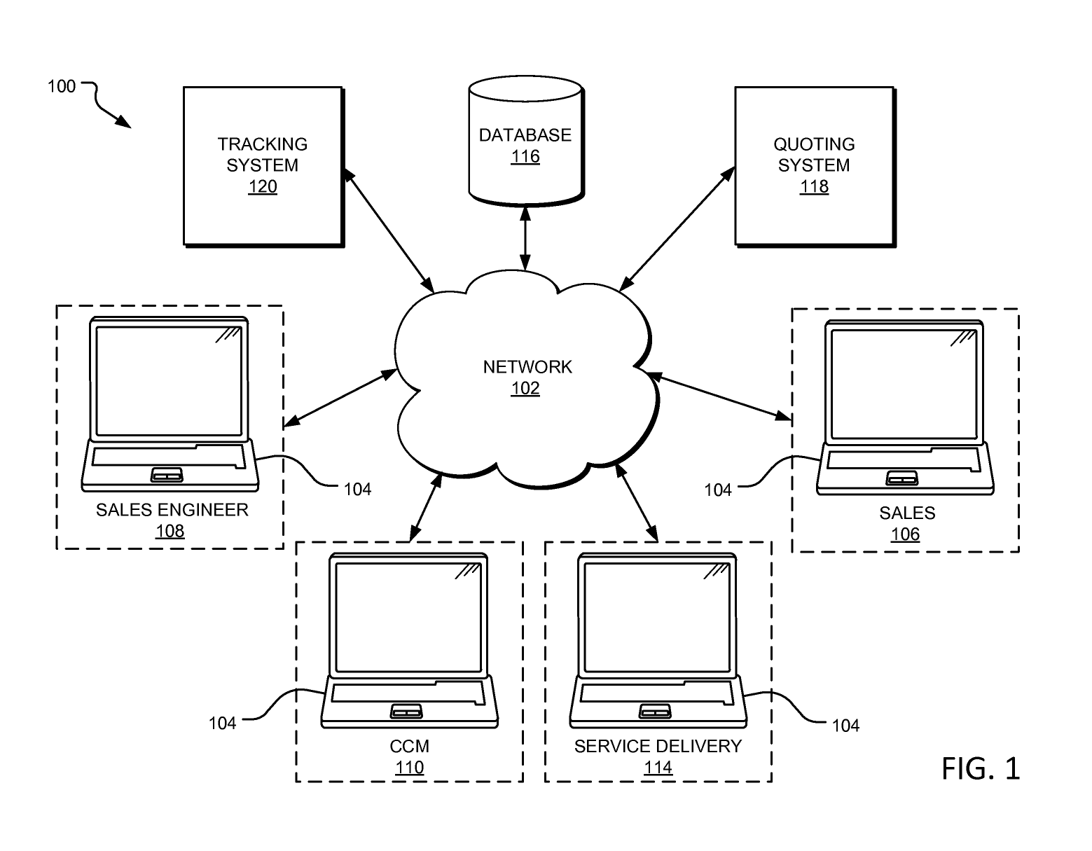

Referring to FIG. 1, an example order management system 100 for quality order tracking is shown. In one implementation, a user accesses and interacts with the order management system 100 to process and track orders via a network 102 (e.g., the Internet) using a user device 104. The user may be any person associated with the company offering products. For example, a telecommunication provider offering telecommunication products or services may include various users, such as a sales representative 106, a sales engineer 108, a customer care manager (CCM) 110, service delivery personnel 114, internal or external auditors, and/or other responsible parties.

The user device 104 is generally any form of computing device capable of interacting with the network 102, such as a personal computer, terminal, workstation, portable computer, mobile device, a tablet, a multimedia console, etc. The network 102 is used by one or more computing or data storage devices (e.g., one or more databases 116) for implementing a quoting system 118, a tracking system 120, and other services, applications, or modules in the order management system 100.

In one implementation, the network 102 includes a server hosting a website or an application that the user may visit to access the quoting system 118, the tracking system 120, and/or other network components or computing devices. The server may be a single server, a plurality of servers with each such server being a physical server or a virtual machine, or a collection of both physical servers and virtual machines. In another implementation, a cloud hosts one or more components of the order management system 100. The user devices 104, the server, and other resources connected to the network 102 may access one or more other servers to access to one or more websites, applications, web services interfaces, storage devices, computing devices, etc. that are used for quality order tracking. The server may also host a search engine that the order management system 100 uses for accessing, searching for, and modifying quote data, order data, product data, customer data, and/or other information.

As can be understood from FIG. 1, in one implementation, the sales representative 106 utilizes the quoting system 118 to input order attributes to receive a quote for a customer for one or more product types. The product types may include various telecommunications services, for example BPN, LAN, Internet product, or the like. The quoting system 118 may be any system, tool, or application capable of generating a quote for a particular customer for various product types. For example, the quoting system 118 may include various quoting tools, such as IFO, Siebel, Pipeline, and/or the like. In one implementation, the sales representative 106 enters customer information and product information to receive a quote for the product and customer, generated by the quoting system 118. Once the customer accepts the quote, an order is submitted by the sales representative 106. In one implementation, the sales engineer 108 attaches product information or technical attributes to the quote and/or order.

Because of the complex nature of telecommunications services and to increase customer satisfaction by quickly and efficiently moving the order process forward to deliver the desired products, the sales representative 106 often obtains a quote with insufficient data. Stated differently, the sales representative 106 obtains sufficient data to generate a quote permitting the customer to understand the costs for receiving the product, but there may be defects in the corresponding order, such as insufficient data to provision the product. For example, critical order attributes necessary to complete the order may be missing or inadequate.

Generally, orders are processed for provisioning by a factory. For example, in the telecommunications industry, the factory may install and activate telecommunications products or services based on details included in an order. To prevent the defects from flowing into the factory, which processes the order for delivery, a user, such as the CCM 110, sales delivery personnel 114, or other responsible party, utilizes the tracking system 120 to track an order in substantially real time and make any corrections to the order before releasing the order to the factory. In one implementation, the tracking system 120 assists in provisioning products correct the first time by improving order quality early in the process and reducing rework late in the process.

To accomplish this, in one implementation, upon receiving an order for a product, the tracking system 114 extracts and collates information relating to critical attributes that are necessary to complete the order, and the order is assigned to an auditor, such as the CCM 110, for review.

In one implementation, the sales representative 106 and/or the sales engineer 108 define critical-to-quality rules for the product type for automated attribute verification. The critical-to-quality rules may be pass/fail rules, such that the information from the order is compared to critical attributes to determine if the order passes each of the critical-to-quality rules. The tracking system 120 runs a script to automatically validate the information in the order relating to the critical attributes using the defined critical-to-quality rules. In one implementation, the tracking system 120 organizes the results of the automatic attribute verification by listing each of the critical-to-quality rules and specifying whether the order passed or failed the rule.

Generally concurrently to the automatic attribute verification, in one implementation, the assigned auditor (e.g., the CCM 110) is reviewing the order. Stated differently, the order is processed using both an automated and a manual review. The CCM 110 may enter additional manual critical-to-quality rules for automatic verification, manually enter whether the order passes or fails one of the critical-to-quality rules, and/or take other action in passing or failing attributes of the order. In one implementation, the CCM 110 reviews the results of the automatic attribute verification to determine whether the results are correct.

The results of the automatic validation and the manual auditor review are collated to determine if the order passes or fails. In one implementation, the auditor review overrules the results of the automatic attribute verification. As such, if the order passes the automatic validation but fails the manual review of one of the critical-to-quality rules, the order is deemed as failing the rule.

If the order failed one or more of the automatic validation and/or the auditor review, the tracking system 120 designates the order as failing and submits the order into a feedback loop that forces the defects to be addressed prior to the order being released to the factory for provisioning the product.

In one implementation, the tracking system 120 provides notification (e.g., an email, alert, etc.) to one or more responsible parties that the order failed. For example, the tracking system 120 may provide a notification to the sales representative 106, the sales engineer 108, the CCM 110, and other directors or quality control personnel. The notification includes an overview of the defects present in the order, such as missing or inadequate critical attributes, and/or instructions for correcting defects in the order. In one implementation, the notification includes a link to the order to update or attach critical attributes in the tracking system 120. In another implementation, where the notification is an email, the user may reply to the email attaching critical attributes to address the defects in the order, which may be extracted and input using the tracking system 120.

The flexibility of the notifications and remedying process empowers various members of the company to collaborate in correcting defects to keep the order process efficiently moving forward to completion. In one implementation, the tracking system 120 permits defects to be generally addressed on the fly, rather than sending the order back to the beginning of the process for reworking. Sending the order back to the start of the process may result in the sales representative 106 and/or the customer having to be involved in the reworking. By not involving the sales representative 106 unnecessarily in the correction process, the sales representative 106 can focus on productivity and customer relations. Further, involving the customer, such as having the customer sign off on the order again, after an order has already been submitted for processing may damage customer satisfaction. Once the order is corrected and passes the automatic and manual review processes, the tracking system 120 releases the corrected order to the sales delivery 114 for further processing and/or release to the factory.

In one implementation, the tracking system 120 generates analytics and business intelligence based on information from one or more orders. The analytics may include trends, for example, over intervals in a time period or according to product type. The analytics may be used to identify an accountable party or common issue, to prevent recurring defects, and to provide a snapshot of order quality. For example, if many of the orders submitted by the sales representative 106 include the same defect, it may indicate carelessness on the part of the sales representative 106, a need for training, or the presence of a technical issue. Similarly, if orders for a particular product often include the same defect, it may indicate a need for training or revision of the order process for the particular product, for example, adding an additional tier of critical attribute analysis before releasing the order to the sale delivery 114.

The tracking system 120 provides uniformity in tracking order quality and corrections, thereby efficiently managing the order process and collecting data for auditing and to assist in trend and high bar analysis to identify and address recurring defects. This information may be used to optimize the sales process, improve order quality early in the process, and reduce rework late in the process, saving money and improving customer satisfaction. The order management system 100 prevents defects from entering the factory or product systems and institutes strategic and tactical quality fixes to ensure sustainable clean order quality.

For example, in a telecommunication ecosystem, Internet Protocol (IP) and virtual private network (VPN) product configuration is a continuously evolving process, but often most in demand. Due to non-standardization of product configuration, there is a significant opportunity to prevent a flow of defective attributes into provisioned products, for example, and Internet Protocol (IP) configuration, bandwidth details, modem technical details, or the like. The tracking system 120 provides a standardization of flow of attributes into order entry and workflow systems, and thus establishes a standard for IP and VPN products.

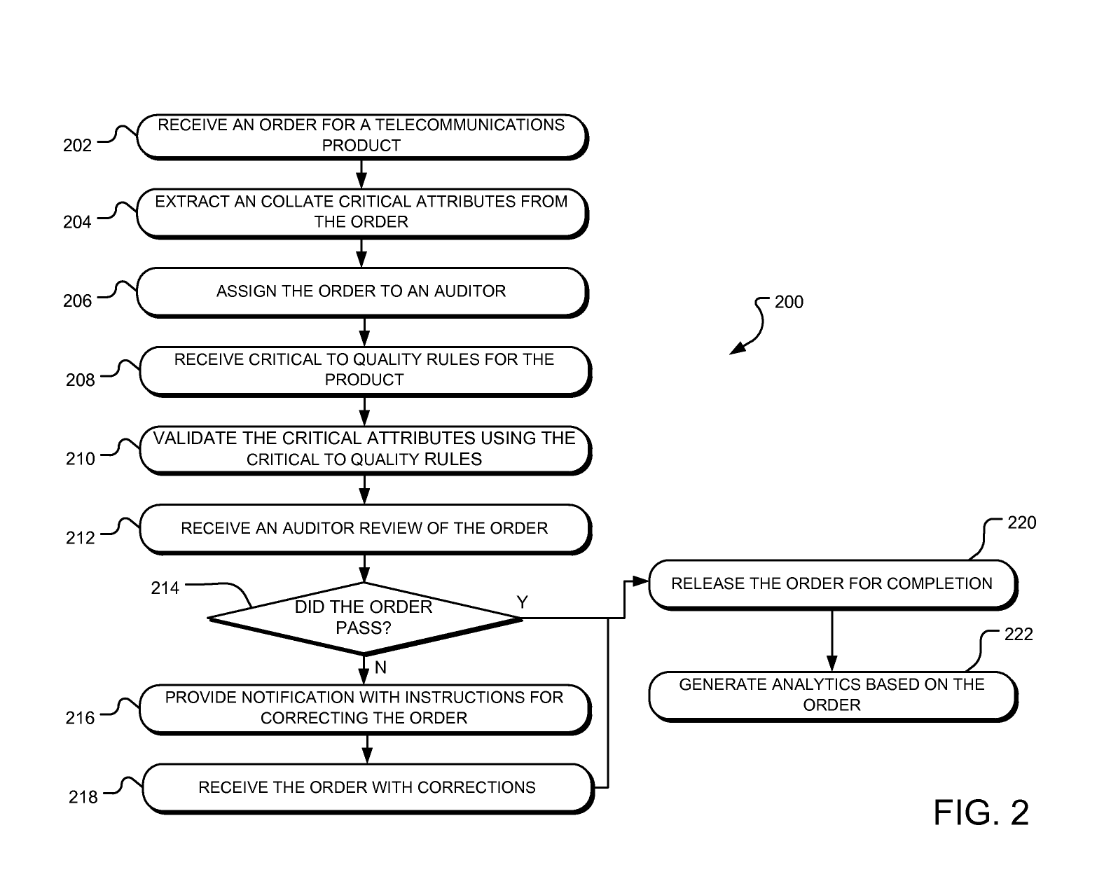

For a detailed description of example operations 200 for quality order tracking, reference is made to FIG. 2. In one implementation, an operation 202 receives an order for a product, such as one or more telecommunications products or services. An operation 204 extracts and collates information relating to critical attributes from the order that are necessary to provision the order.

An operation 206 assigns the order to an auditor for review. In one implementation, the auditor is an external auditor. In another implementation, the auditor is an internal auditor, such as a customer care manager. An operation 208 receives critical-to-quality rules defined for the ordered product type. In one implementation, the critical-to-quality rules are defined by a sales representative and/or sales engineer.

An operation 210 automatically validates the information in the order relating to the critical attributes using the critical-to-quality rules. In one implementation, the critical-to-quality rules include one or more pass/fail rules. An operation 212 receives and collates the results of the automatic validation and an auditor review. In one implementation, the results of the auditor review overrule the results of the automatic validation.

An operation 214 determines whether the order passes or fails based on the collated results of the automatic validation and the auditor review. In one implementation, if the order failed one or more of the critical-to-quality rules and/or the auditor review, the operation 214 fails the order and submits the order into a feedback loop that forces the defects to be addressed prior to the order being released to the factory for provisioning the product. In this case, an operation 216 provides a notification with instructions for correcting defects in the order, such as missing or inadequate critical attributes. In one implementation, the defects are changed on the fly. An operation 218 receives the order with corrections. Once the order is corrected and passes the automatic and auditor review operations or if the operation 214 passes the order, an operation 220 releases the order for provisioning the product.

In one implementation, an operation 222 generates analytics and business intelligence based on the order. The analytics may include trends, for example, over intervals in a time period or according to product type. The analytics may be used to identify an accountable party or issue, to prevent recurring defects, and to provide a snapshot of order quality.

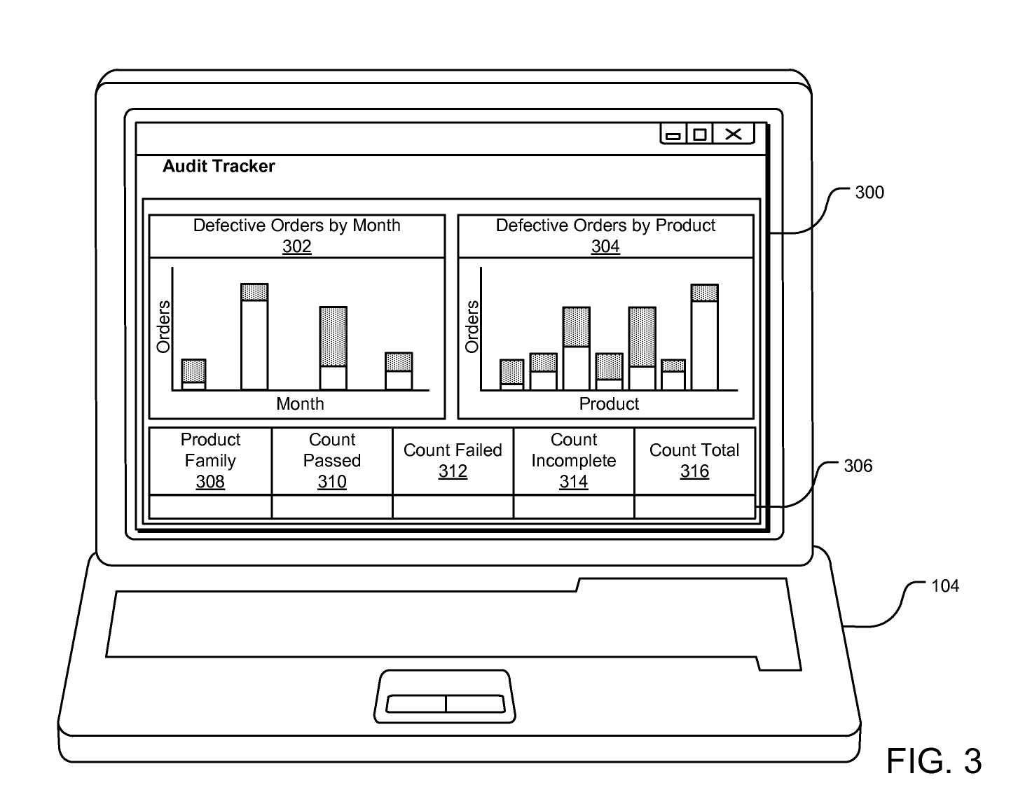

FIGS. 3-5 show example user interfaces generated by the tracking system 120 and displayed in a browser window of the user device 104 through which access to and interactions with quotes, orders, records, analytics, and other data is provided. It will be appreciated by those skilled in the art that such depictions are exemplary only and not intended to be limiting.

In one implementation, a user, such as the sales representative 106, the sales engineer 108, the CCM 110, sales delivery personnel 112, internal or external auditors, directors, or other responsible parties accesses the order management system 100 via a link in an email, alert, or other notification. In another implementation, the user accesses the order management system 100 directly by logging into an account.

FIG. 3 shows an example audit tracker user interface 300. As can be understood from FIG. 3, in one implementation, the audit tracker 300 displays analytics and business intelligence relating to defects in orders for a variety of products.

In the example shown in FIG. 3, the analytics and business intelligence includes charts 302 and 304 showing trending and product breakdown. The chart 302 displays defective orders by month, and the chart 304 depicts defective orders by product type or family. In one implementation, the charts 302 and 304 show the total orders broken down by the amount that pass and the amount that fail. For example, the shaded portion of each of the bars reflecting the total order for either the month or product type may represent the portion of the total orders that failed, and the unshaded portion may represent the portion of the total orders that passed. Various colors, design, shading, or other visual representations may be used to indicate the portions that passed and failed. The analytics and business intelligence may be broken down and displayed based on various criteria, including, but not limited to, time interval, product type or family, passed and failed audits, orders in queue waiting for audit, or the like.

In one implementation, clicking on a portion of the charts 302 or 304 generates and displays a drill down list 306, which provides a numerical breakdown of the analytics displayed in the selected portion of the charts 302 or 304. For example, as shown in FIG. 3, the drill down list 306 may list a product family 308, a count passed 310, a count failed 312, a count incomplete 314, and a count total 316.

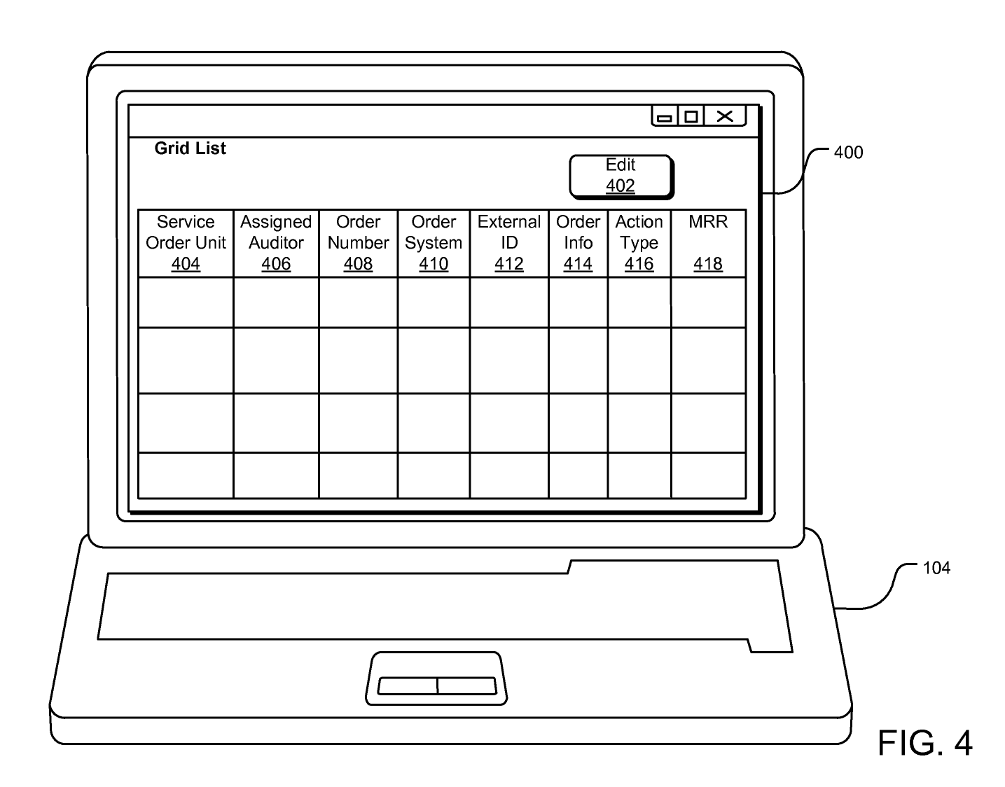

The drill down list 306 may include one or more links, which may be selected to direct the user to a grid list. For a detailed description of an example grid list 400 for tracking order quality, reference is made to FIG. 4. In one implementation, the grid list 400 is filtered according to user chosen criteria.

As shown in FIG. 4, in one implementation, the grid list 400 includes an edit button 402 allowing the user to edit or cancel an order or assign an auditor the order. There may be separate edit buttons 402 or links for each order or a single edit button 402 with options for selecting one or more orders.

In one implementation, the grid list 400 includes a service order unit 404, an assigned auditor 406, an order number 408, an order system 410, an external identification 412, order information 414, an action type 416, and a monthly recurring revenue (MRR) 418. The assigned auditor 406 includes information relating to the auditor assigned the work order, including a name and contact information of an internal and/or external auditor, a date the auditor was assigned, and the like. The order system 410 details the quoting tool utilized in taking the order, such as IFO, Siebel, Pipeline, and/or the like. The order information 414 includes information relating to the order, such as an order status (e.g., accepted, denied, etc.), an order type (e.g., new), and the like. The action type 416 refers to the type of action required by the order (e.g., an install). In one implementation, the order system 410, the external identification 412, the order information 414, the action type 416, and the MRR 418 are extracted from the quoting system 118 used in taking the order.

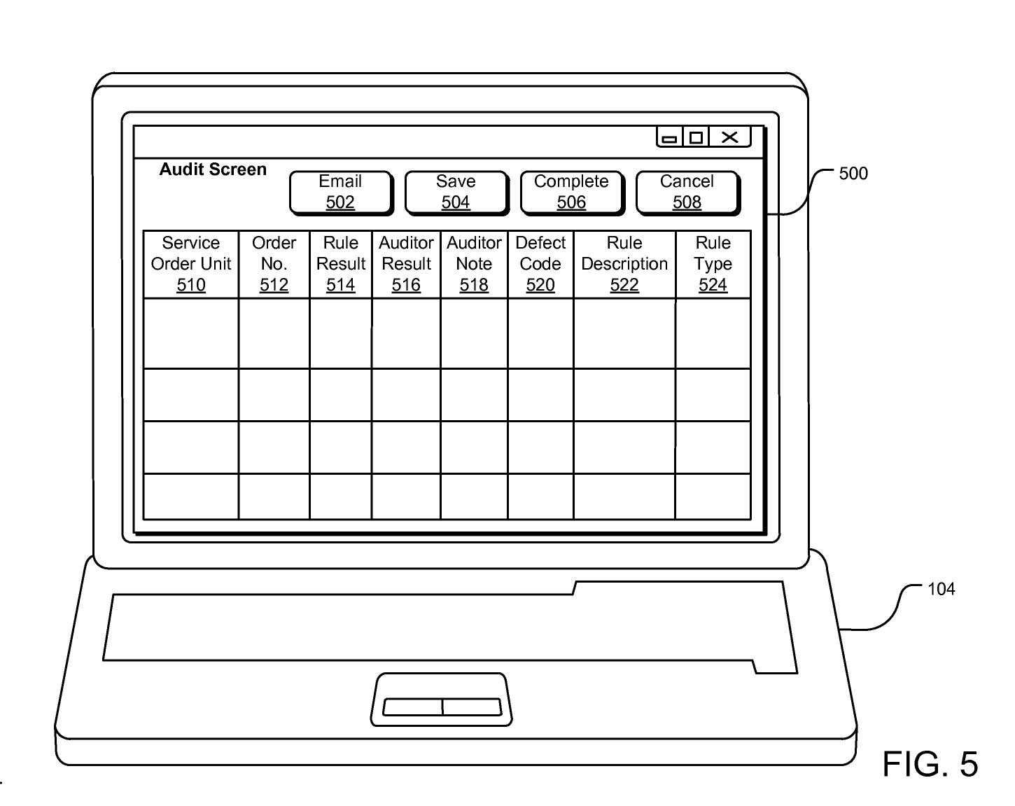

The grid list 400 may include one or more links which may be selected to direct the user to an audit screen providing additional detail on an order. For a detailed description of an example audit screen 500 for tracking order quality, reference is made to FIG. 5.

As shown in FIG. 5, the audit screen 500 includes an email button 502 for emailing order results to a responsible group or director, a save button 504 to save the results of the audit, a complete button 506 to complete the order, and a cancel button 508 to cancel the order.

In one implementation, the audit screen 500 details a service order unit 510, an order number 512, a rule result 514, an auditor result 516, auditor notes 518, a defect code 520, a rule description 522, and a rule type 524. The service order unit 510 shows the service order being audited. The rule result 514 displays the results of an automated validation of a critical-to-quality rule (e.g., pass or fail), and the auditor result 516, auditor notes 518, and defect code 520 show the result of the manual auditor review. For example, the auditor result 516 may be a pass/fail result for the critical-to-quality rule, which overrules the result shown in the rule result 514. The auditor notes 518 may include various notes supporting the auditor result 516, and the defect code 520 may indicate the nature of any defects present that were missed during the automated validation. The rules description 522 details the critical-to-quality rule being evaluated, and the rule type 524 indicates whether the rule is manual or automatic.

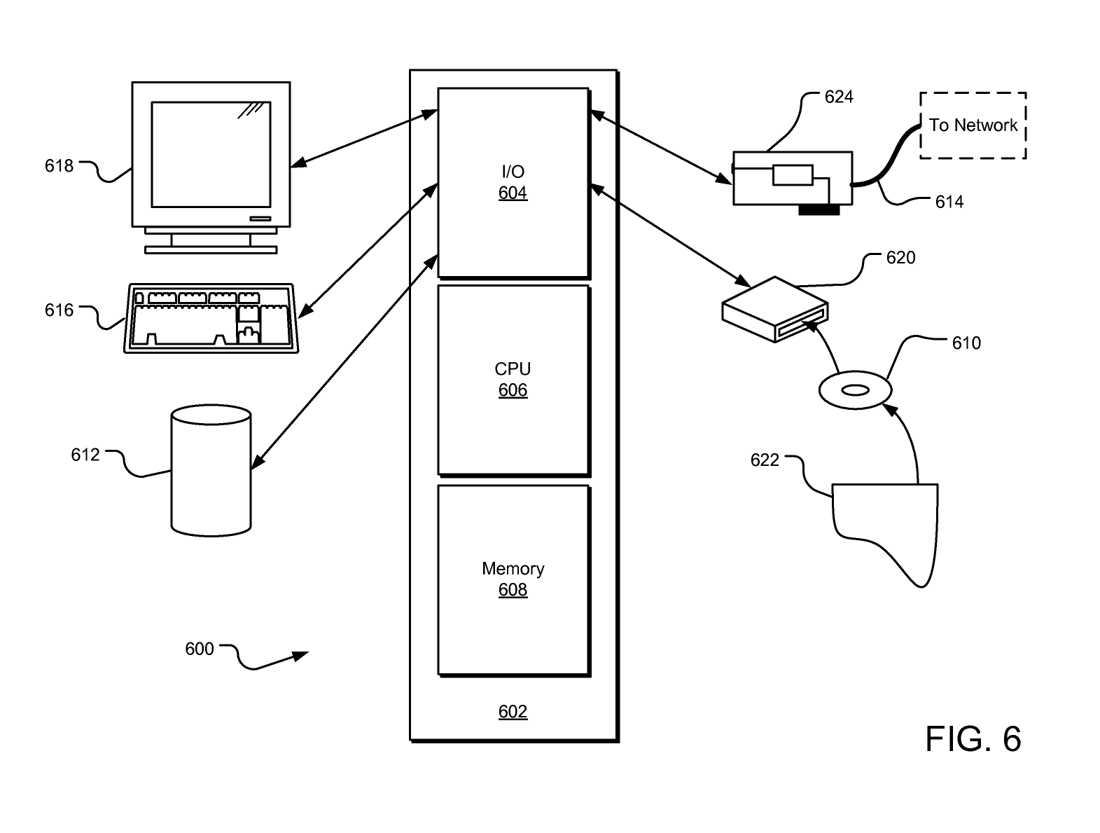

Referring to FIG. 6, a detailed description of an example computing system 600 having one or more computing devices that may implement various systems and methods discussed herein is provided. The computing system 600 may be applicable to the user device 104, the server, or other computing devices. It will be appreciated that specific implementations of these devices may be of differing possible specific computing architectures not all of which are specifically discussed herein but will be understood by those of ordinary skill in the art.

The computing system 600 may be a general purpose computer system capable of executing a computer program product to execute a computer process. Data and program files may be input to the computer system 600, which reads the files and executes the programs therein. Some of the elements of a general purpose computer system 600 are shown in FIG. 6 wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer, such as one or more external computers made available via a cloud computing architecture. The presently described technology is optionally implemented in software devices loaded in memory 608, stored on a configured DVD/CD-ROM 610 or storage unit 612, and/or communicated via a wired or wireless network link 614, thereby transforming the computer system 600 in FIG. 6 to a special purpose machine for implementing the described operations.

The I/O section 604 is connected to one or more user-interface devices (e.g., a keyboard 616 and a display unit 618), a disc storage unit 612, and a disc drive unit 620. Generally, the disc drive unit 620 is a DVD/CD-ROM drive unit capable of reading the DVD/CD-ROM medium 610, which typically contains programs and data 622. Computer program products containing mechanisms to effectuate the systems and methods in accordance with the presently described technology may reside in the memory section 604, on a disc storage unit 612, on the DVD/CD-ROM medium 610 of the computer system 600, or on external storage devices made available via a cloud computing architecture with such computer program products, including one or more database management products, web server products, application server products, and/or other additional software components. Alternatively, a disc drive unit 620 may be replaced or supplemented by an optical drive unit, a flash drive unit, magnetic drive unit, or other storage medium drive unit. Similarly, the disc drive unit 620 may be replaced or supplemented with random access memory (RAM), magnetic memory, optical memory, and/or various other possible forms of semiconductor based memories commonly found in smart phones and tablets.

The network adapter 624 is capable of connecting the computer system 600 to a network via the network link 614, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as mobile phones, tablets, multimedia consoles, gaming consoles, set top boxes, etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are examples of communications devices for and other means of establishing a communications link between the computers may be used.

In an example implementation, order and quote data, critical attributes, tracking data, trend and high bar data, a plurality of internal and external databases (e.g., the database 116), source databases, and/or data cached on cloud servers are stored as the memory 608 or other storage systems, such as the disk storage unit 612 or the DVD/CD-ROM medium 610, and/or other external storage devices made available and accessible via a cloud computing architecture. Quote generation and tracking software and other modules and services may be embodied by instructions stored on such storage systems and executed by the processor 602.

Some or all of the operations described herein may be performed by the processor 602. Further, local computing systems, remote data sources and/or services, and other associated logic represent firmware, hardware, and/or software configured to control operations of the order management system 100. Such services may be implemented using a general purpose computer and specialized software (such as a server executing service software), a special purpose computing system and specialized software (such as a mobile device or network appliance executing service software), or other computing configurations. In addition, one or more functionalities of the order management system 100 disclosed herein may be generated by the processor 602 and a user may interact with a Graphical User Interface (GUI) using one or more user-interface devices (e.g., the keyboard 616, the display unit 618, and the user devices 104) with some of the data in use directly coming from online sources and data stores. The system set forth in FIG. 6 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions. The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various implementations, it will be understood that these implementations are illustrative and that the scope of the disclosure is not limited to them. Many variations, modifications, additions, and improvements are possible. More generally, aspects of the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A method for increasing order quality comprising:
receiving an order for a product using at least one computing device;
extracting information corresponding to critical order attributes from the order using the at least one computing device, the critical order attributes including technical data for provisioning the product;
validating the information automatically using the at least one computing device according to a set of critical-to-quality rules defined based on the product; and
determining whether the order is complete for release to provision the product based on the validated information using the at least one computing device.

2. The method of claim 1, wherein the validated information indicates the order is incomplete where at least a portion of the information fails the set of critical-to-quality rules.

3. The method of claim 2, further comprising:
generating a notification with instructions for correcting the order based on the failed information.

4. The method of claim 3, further comprising:
releasing the corrected order for provisioning the product.

5. The method of claim 1, wherein the validated information indicates the order is complete where the information passes an entirety of the set of critical-to-quality rules.

6. The method of claim 5, further comprising:
releasing the completed order for provisioning the product.

7. The method of claim 1, further comprising:
receiving an auditor review of the information using the at least one computing device, the auditor review assigning a pass/fail status to the order.

8. The method of claim 7, further comprising:
collating the validated information with the auditor review to obtain an order status using the at least one computing device.

9. The method of claim 8, wherein the determination of whether the order is complete is based on the order status.

10. The method of claim 9, wherein the order is incomplete where the order status is fail and the order is complete where the order status is pass.

11. The method of claim 10, wherein the order status is fail where at least one of the following is true: the pass/fail status of the auditor review is fail or at least a portion of the information fails the set of critical-to-quality rules.

12. The method of claim 10, wherein the order status is pass where both the pass/fail status of the auditor review is pass and the information passes an entirety of the set of critical-to-quality rules.

13. One or more non-transitory tangible computer-readable storage media storing computer-executable instructions for performing a computer process on a computing system, the computer process comprising:
receiving an order for a product;
extracting information corresponding to critical order attributes from the order, the critical order attributes including technical data for provisioning the product;
validating the information automatically according to a set of critical-to-quality rules defined based on the product;
receiving an auditor review of the information, the auditor review assigning a pass/fail status to the order;
collating the validated information with the auditor review to obtain an order status; and
determining whether the order is complete for release to provision the product based on the order status.

14. The one or more non-transitory tangible computer-readable storage media of claim 13, wherein the order is incomplete where the order status is fail and the order is complete where the order status is pass.

15. The one or more non-transitory tangible computer-readable storage media of claim 14, wherein the order status is fail where at least one of the following is true: the pass/fail status of the auditor review is fail or at least a portion of the information fails the set of critical-to-quality rules.

16. The one or more non-transitory tangible computer-readable storage media of claim 14, wherein the order status is pass where both the pass/fail status of the auditor review is pass and the information passes an entirety of the set of critical-to-quality rules.

17. A system for increasing order quality comprising:
at least one server configured to determine whether an order is complete for release to provision a product based on an order status generated according to a collation of an automatic validation of information and an auditor review of the information, the automatic validation based on a set of critical-to-quality rules, the auditor review assigning a pass/fail status to the order, the information corresponding to critical order attributes extracted from the order, the critical order attributes including technical data for provisioning the product; and
one or more databases in communication with the at least one server, the one or more databases configured to store the order based on the order status.

18. The system of claim 17, wherein the order is incomplete where the order status is fail and the order is complete where the order status is pass.

19. The system of claim 18, wherein the order status is fail where at least one of the following is true: the pass/fail status of the auditor review is fail or at least a portion of the information fails the set of critical-to-quality rules.

20. The system of claim 18, wherein the order status is pass where both the pass/fail status of the auditor review is pass and the information passes an entirety of the set of critical-to-quality rules.
